(19) United States
(12) Patent Application Publication
(10) Pub. No.: US 2004/0254862 A1
(43) Pub. Date: Dec. 16, 2004

(54) Inventory management system and method

(76) Inventors: Sheng Chi Luo, Tu-Chen (TW); XiaoRong Wu, Shenzhen (CN); Wei Zhang, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/867,989

(22) Filed: Jun. 14, 2004

(30) Foreign Application Priority Data
Jun. 13, 2003 (TW) 92116168

(51) Int. Cl. G06F 17/60

(52) U.S. Cl. 705/28

(57) ABSTRACT

An inventory management system includes a plurality of client computers (6), a database server (4) comprising a database (40) for storing inventory information, an application server (2) for monitoring and managing inventory, and a network (5) interconnecting all the above entities. The application server includes a basic data maintenance module (21) provided for maintaining inventory information stored in the database; a data analyzing module (22) provided for calculating stock ages for materials, analyzing quantities and prices for all abnormal materials, and integrating inventory information on the abnormal materials from various storage locations; and an alert module (23) provided for generating alerts according to the integrated inventory information on the abnormal materials. A related inventory management method is also disclosed.

### BACKGROUND OF THE INVENTION

1. Field of the Invention

The present invention relates to inventory management systems and methods, and especially to an inventory management system and method capable of calculating stock ages for various materials, and of generating alerts according to inventory information on abnormal materials.

2. Background of the Invention

Conventional inventory management systems and methods involve a large number of manually conducted tasks. These systems are typically highly labor intensive. Numerous manual steps inevitably lead to human error. For example, amounts of inventory in storage locations are determined by visual inspection of hard goods and by using dipsticks for liquids. The determined amounts are then evaluated to ascertain if more inventory is needed. These methods can lead to inaccurate measurements of inventory amounts. Time delays are common if not inevitable. Accurate inventory levels cannot be obtained in real-time.

Automated computer managed inventory systems have been adopted to overcome some of the above-mentioned shortcomings. One such system is disclosed in U.S. Pat. No. 6,341,271 issued on Jan. 22, 2002 and entitled Inventory Management System and Method. The system comprises at least one storage receptacle that stores inventory; at least one amount indicator that determines an inventory amount in each receptacle; at least one inventory price source that provides inventory price information; and a control unit that receives inventory amount signals from the at least one amount indicator and inventory price information from the at least one inventory price source. The control unit analyzes the inventory amount signals to determine amounts in the receptacle. The control unit also analyzes the amounts and inventory price information, and uses this information to determine if an inventory order should be placed.

The method disclosed in this patent comprises the steps of: determining an inventory amount in each receptacle; generating signals representative of inventory amounts; providing inventory price information from at least one inventory price source; receiving inventory amount signals; receiving inventory price information from the at least one inventory price source; analyzing inventory amount signals and inventory price information; determining if an inventory order should be placed based on the analyzed inventory amounts and inventory price information; and providing information concerning an inventory order in an accessible form to at least one of a manufacturing site and an inventory vendor.

This patent is particularly directed to vendor-managed inventory systems and methods, and aimed to provide information concerning inventory amounts and inventory ordering to a manufacturing site and an inventory vendor. No means are disclosed in this patent for calculating stock ages for various materials, nor for managing of those materials having abnormal stock ages. In particular, there are no means for generating alerts according to inventory information on abnormal materials.

### SUMMARY OF THE INVENTION

A main objective of the present invention is to provide an inventory management system and method which can calculate stock ages for materials, and generate alerts according to inventory information on abnormal materials.

To achieve the above objective, an inventory management system in accordance with the present invention comprises an application server, a database server, a plurality of client computers, and a network interconnecting all the above entities. The database server comprises a database for storing inventory information. Such inventory information includes item numbers, material names, quantities and prices for various materials, storage locations, stock ages, supplier names, and names of departments that use the materials. The application server monitors and manages inventory for various materials. The application server comprises: a basic data maintenance module for maintaining inventory information stored in the database; a data analyzing module for calculating stock ages for materials, analyzing quantities and prices for abnormal materials, and integrating inventory information on the abnormal materials from various storage locations; and an alert module for generating alerts according to the integrated inventory information on the abnormal materials.

Further, the present invention provides an inventory management method comprising the steps of: calculating stocks ages for various materials; determining whether any materials are abnormal, by comparing the calculated stock ages with their respective standard stock ages; obtaining inventory quantities for all abnormal materials; obtaining prices for the abnormal materials; integrating inventory information on the abnormal materials from various storage locations; generating statistical reports according to the integrated inventory information; and generating alerts according to the statistical reports.

Other objects, advantages and novel features of the present invention will be drawn from the following detailed description of a preferred embodiment and preferred method of the present invention with the attached drawings, in which:

### BRIEF DESCRIPTION OF THE DRAWINGS

FIG. 1 is a schematic diagram of hardware architecture of an inventory management system in accordance with the preferred embodiment of the present invention;

FIG. 2 is a schematic diagram showing main function modules of an application server of FIG. 1;

FIG. 3 is a schematic diagram of main software sub-modules of a data analyzing module of FIG. 2; and

FIG. 4 is a flow chart of a preferred inventory management method in accordance with the present invention.

### DETAILED DESCRIPTION OF THE INVENTION

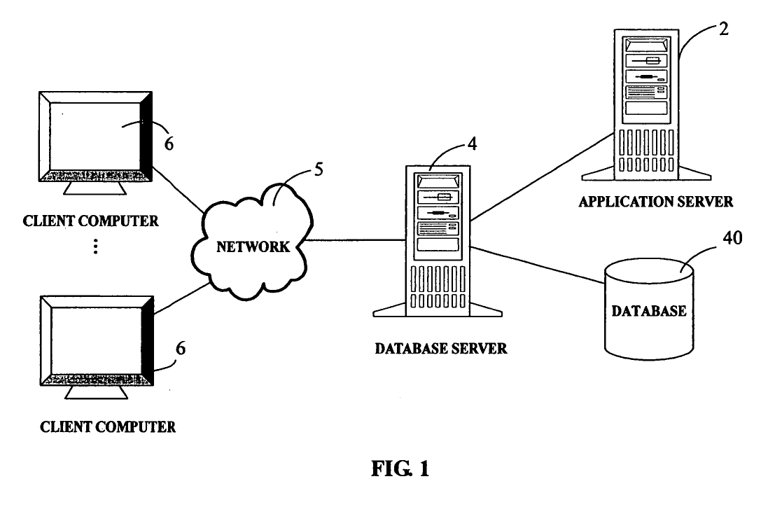

FIG. 1 is a diagram of hardware architecture of an inventory management system in accordance with the preferred embodiment of the present invention. The inventory management system comprises an application server 2, a database server 4, and a plurality of client computers 6. The client computers 6 are connected with the database server 4 through a network 5. The network 5 may be an intranet, the Internet or any other suitable electronic communications network. The database server 4 comprises a database 40 for storing inventory information. Such inventory information may include item numbers, material names, quantities and prices for various materials, storage locations, stock ages, supplier names, and names of departments that use the materials. Such departments may, for example, be various departments in a manufacturing company. Users of the client computers 6 may be purchasing superintendents, purchasing staff, inventory managers, and warehouse staff. By inquiring of inventory information in the database 40 via the network 5, the users can monitor inventory status, and timely perform purchasing operations.

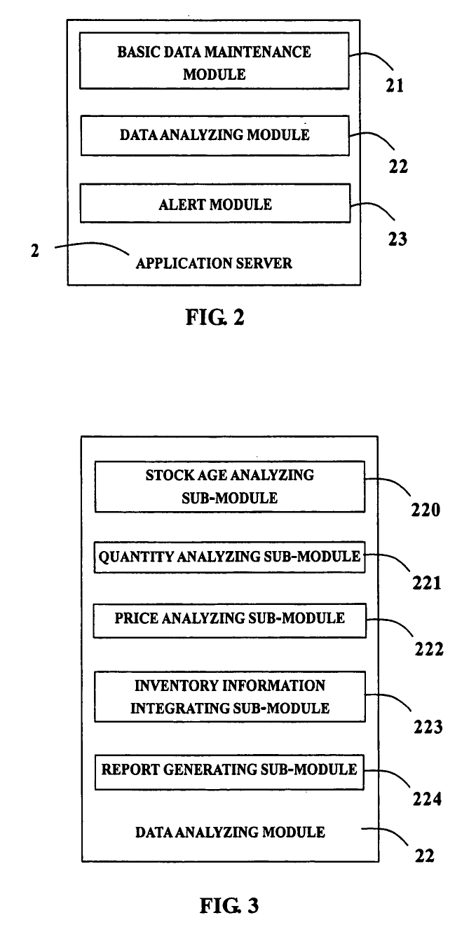

FIG. 2 is a diagram showing main function modules of the application server 2. The application server 2 executes various software applications for monitoring and managing inventory. The application server 2 comprises a basic data maintenance module 21, a data analyzing module 22, and an alert module 23. The basic data maintenance module 21 is provided for maintaining inventory information stored in the database 40, especially for updating corresponding information in real time when inventory is changed. The data analyzing module 22 is provided for calculating stock ages for inventory, analyzing quantities and prices of materials, and integrating inventory information on abnormal materials from various storage locations (see below). The data analyzing module 22 can also generate statistical reports about the abnormal materials. The statistical reports may be in the form of organized (.pdf, tif etc.) or non-organized (.xls, .mdb etc.) documents. The alert module 23 can generate alerts according to the statistical reports, and transmit the alerts to the client computers 6 for users to perform appropriate remedial inventory management.

Functional sub-modules of the data analyzing module 22 are shown in FIG. 3. The data analyzing module 22 comprises a stock age analyzing sub-module 220, an inventory quantity analyzing sub-module 221, a material price analyzing sub-module 222, an inventory information integrating sub-module 223, and a report generating sub-module 224. Stock ages are calculated by the stock age analyzing sub-module 220 according to stock receipt times, stock dispatch times, and current times. If a material has been dispatched from a warehouse, the stock age equals its dispatch time minus its receipt time. If a material is still in a warehouse, the stock age equals the current time minus its receipt time. The stock age analyzing sub-module 220 can also compare a material's stock age with its standard stock age as predetermined by inventory managers, in order to determine whether the material is abnormal. So-called abnormal material is defined as a material whose stock age is greater than its standard stock age. So-called normal material is defined as a material whose stock age is less than or equal to its standard stock age.

The inventory quantity analyzing sub-module 221 and material price analyzing sub-module 222 respectively obtain inventory quantities and material prices for abnormal materials from the database 40. The material prices may be actual purchasing prices, expected prices, or differences between actual purchasing prices and expected prices. An expected price means a price that purchasing staff expect to have to pay for a material before actually buying the material. The inventory information integrating sub-module 223 is for integrating inventory information on abnormal materials from various storage locations. The report generating sub-module 224 is provided for exporting the information generated by the inventory information integrating sub-module 223 to various electronic documents. The documents may be organized (e.g. .pdf, tif, etc.) or non-organized (e.g. .xls, .mdb, etc.).

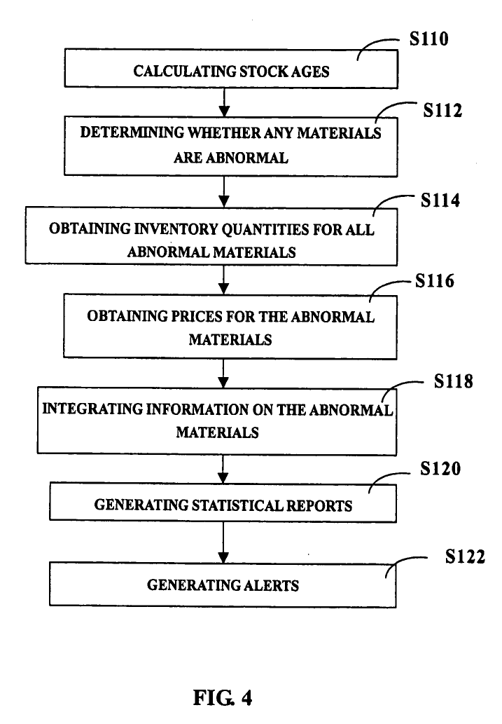

FIG. 4 is a flow chart of a preferred inventory management method in accordance with the present invention. The method is implemented using the above-described inventory management system. In step S110, the stock age analyzing sub-module 220 calculates stock ages for various materials. In step S112, the stock age analyzing sub-module 220 determines whether any materials are abnormal, by comparing the calculated stock ages with their respective standard stock ages. The stock age analyzing sub-module 220 then gathers information on all abnormal materials identified. Such information may include item numbers and material names. In step S114, the quantity analyzing sub-module 221 obtains inventory quantities of the abnormal materials from the database 40. In step S116, the price analyzing sub-module 222 obtains prices of the abnormal materials. In step S118, the inventory information integrating sub-module 223 integrates information on the abnormal materials from various storage locations. In step S120, the report generating sub-module 224 generates statistical reports according to the information integrated by the inventory information integrating sub-module 223. In step S122, the alert module 23 generates alerts according to the statistical reports. The alerts are then transmitted to corresponding staff at client computers 6 via the network 5, so that appropriate remedial inventory management can be promptly carried out. The alerts may be transmitted by way of e-mails, phone messages and/or voice mail messages.

Although the present invention has been described in language specific to structural features and/or methodological steps, it is to be understood that the invention defined in the appended claims is not necessarily limited to the specific features or steps described above. Rather, the above-described specific features and steps are disclosed as preferred forms of implementing the claimed invention.

What is claimed is:

1. An inventory management system for calculating stock ages for materials and generating alerts according to information on abnormal materials, the inventory management system comprising:
a database server comprising a database for storing inventory information, said inventory information including item numbers, material names, quantities and prices for various materials, storage locations, stock ages, supplier names, and names of users of the materials; and
an application server for monitoring and managing inventory, the application server comprising:
a data analyzing module provided for calculating stock ages for materials, analyzing quantities and prices for abnormal materials, and integrating inventory information on the abnormal materials from various storage locations; and
an alert module provided for generating alerts according to the integrated inventory information on the abnormal materials.

2. The inventory management system as claimed in claim 1, further comprising a basic data maintenance module provided for maintaining inventory information stored in the database.

3. The inventory management system as claimed in claim 1, wherein the data analyzing module comprises:
a stock age analyzing sub-module for calculating stock ages for various materials according to their respective stock receipt times, stock dispatch times, and current times;
an inventory quantity analyzing sub-module for obtaining inventory quantities of abnormal materials from the database;
a material price analyzing sub-module for obtaining prices of abnormal materials from the database;
an inventory information integrating sub-module for integrating inventory information on abnormal materials from various storage locations; and
a report generating sub-module for exporting information to various electronic documents.

4. The inventory management system as claimed in claim 1, wherein the data analyzing module is also for generating statistical reports about materials having abnormal stock ages.

5. A computer-based inventory management method for calculating stock ages for materials and generating alerts according to information on abnormal materials, the method comprising the steps of:
calculating stocks ages for various materials;
determining whether any materials are abnormal, by comparing the calculated stock ages with their respective standard stock ages;
obtaining inventory quantities for any one or more abnormal materials;
obtaining prices for the abnormal materials;
integrating inventory information on the abnormal materials from various storage locations;
generating one or more statistical reports according to the integrated inventory information; and
generating alerts according to the statistical reports.

6. The inventory management method as claimed in claim 5, wherein stock age is calculated by subtracting a stock receipt time from a stock dispatch time when a material has been dispatched from a warehouse, and by subtracting a stock receipt time from a current time when a material is still in a warehouse.

7. The inventory management method as claimed in claim 5, wherein an abnormal material is defined as a material whose stock age is greater than a standard stock age.

8. A computer-based inventory management method for calculating stock ages for materials and generating alerts according to information on abnormal materials, the method comprising the steps of:
calculating stocks ages for various materials;
determining whether any materials are abnormal, by comparing the calculated stock ages with their respective standard stock ages;
obtaining inventory quantities for any one or more abnormal materials;
integrating inventory information on the abnormal materials from various storage locations;
generating one or more statistical reports according to the integrated inventory information; and
generating alerts according to the statistical reports.
